(19) United States
(12) Patent Application Publication
(10) Pub. No.: US 2011/0308099 A1
(43) Pub. Date: Dec. 22, 2011

(54) DEVICE FOR DETERMINING THE CONCRETE COVER OF REINFORCEMENTS DURING CASTING

(76) Inventors: Eberhard Küssner, Bad Durkheim (DE); Andreas Rach, Wittlich (DE); Davide Zampini, Lyss (CH)

(21) Appl. No.: 13/121,491

(22) PCT Filed: Sep. 25, 2009
(86) PCT No.: PCT/EP09/06944

§ 371 Date: Sep. 9, 2011

(30) Foreign Application Priority Data
Oct. 4, 2008 (DE) 20-2008-013-260.3

(51) Int. Cl. G01D 21/00

(52) U.S. Cl. 33/613

(57) ABSTRACT

The disclosure concerns a device for determining the dimension of the upper concrete cover of a concrete component, having at least one fastening by means of which the device can be fixed to a reinforcement for a concrete component and at least one section capable of projecting above the upper concrete cover during casting in the reinforcement, wherein this section presents means of configuration by which the dimension of the upper concrete cover may be determined.

### CROSS-REFERENCE TO RELATED APPLICATIONS

This application is a National Phase Entry of International Application No. PCT/EP2009/006944, filed on Sep. 25, 2009, which claims priority to German Patent Application Serial No. 20 2008 013 260.6, filed on Oct. 4, 2008, both of which are incorporated by reference herein.

### BACKGROUND AND SUMMARY

The invention concerns a device for determining the dimension of the upper concrete cover of a concrete component, a reinforcement for a concrete component in addition to a concrete component.

Concrete components present an internal reinforcement in the form of sectional constructional steels or concrete reinforcing mats. The reinforcement is applied by means of bar spacers at a specific distance in relation to the base on to the production pallet. This reinforcement is cast with concrete in order to manufacture the component. In this case, both the edge distance of the reinforcement in the downwards direction and the edge distance of certain parts of the reinforcement in the upwards direction must be observed. After concreting, the reinforcement must not have any direct contact with the atmosphere surrounding the concrete components, since this would result in the long term in corrosion damage to the reinforcement or damage to the latter in the case of effects of fire. Consequently, the reinforcement within a concrete component must be covered with a minimum dimension by concrete.

The covering accordingly required of the reinforcements located within the concrete components is known as “concrete cover” or “concrete covering”. The concrete cover, which receives the reinforcement on concreting the reinforcement on the site facing the support surface, is usually known as the “lower” or “inner” concrete cover. The opposite concrete cover, which covers the reinforcement on concreting at the top, is known as the “upper” or “outer” concrete cover.

In practice, it is desired that the concrete cover should not be too large, since in this case, the concrete components may become too heavy, which may cause problems for example during transport or static problems when installing these concrete components in a structure. Furthermore, unnecessary quantities of concrete are consumed in this case in finished component structures. On the aforementioned grounds, concrete covers of a specific dimension, i.e. an exact thickness, are desired. In practice however, adjustment of the upper concrete cover in particular with a specific dimension is not possible. For whilst the dimension of the lower concrete cover is adjustable for example owing to the fact that the reinforcement is applied over bar spacers at a specific distance on to a support surface, it has been practically impossible up to now to adjust or determine the dimension of the upper concrete cover.

The invention is based on the problem of providing a device for determination of the dimension of the upper concrete cover of a concrete component. In order to solve this problem, the invention makes available a device for determination of the dimension of the upper concrete cover of a concrete component with at least one fastening by means of which the device can be fixed to a reinforcement of the concrete component and with at least one section capable of projecting above the upper concrete cover on concreting the reinforcement. This section presents means of configuration by which the dimension of the upper concrete cover can be determined.

The basic idea of the invention consequently involves providing a device that is fixable to a reinforcement and presents a section that projects above the concrete at the top when the reinforcement is concreted, i.e. cast over with concrete. By this section projecting above the concrete at the top, the section simultaneously projects over the upper concrete cover of the concrete component. This section capable of projecting above the upper concrete cover presents means of configuration by which the dimension, i.e. the thickness, of the upper concrete cover may be determined. These means of configuration may for example be designed in such a way that the person charged with concreting the reinforcement is able to directly determine whether the necessary dimension of the upper concrete cover has been achieved and observed. The device according to the invention therefore creates a very simple and reliable solution for determining the dimension of the upper concrete cover of a reinforcement.

The device may be fixable by any desired ways and means to the reinforcement of a concrete component. According to a preferred embodiment, the fastening provided for fixing the device to a reinforcement may comprise a clamping system for clamped attachment of the device to the reinforcement. This clamping system may for example involve a clip, so that the device may be clipped on to a reinforcement. Consequently, the device according to the invention is simply and reliably fixable to a reinforcement.

The fastening may present a section capable of at least partially encompassing a steel bar of a reinforcement, for example in the form of an essentially U-shaped recess. This U-shaped recess may for example present a width in the range of 5 to 25 mm, preferably in the range of 10 to 20 mm and for example a depth in the range of 5 to 30 mm, preferably in the range of 15 to 25 mm. By means of an appropriately dimensioned recess, a rebar of usual commercially available dimension may be passed through and therefore a device is easily fixable to such a bar by means of an appropriately dimensioned U-shaped recess.

In order to improve fixing of the device to a bar of a concrete reinforcing mat, the U-shaped recess may present an internal clamping system for clamped attachment of the device to a steel bar of a reinforcement. Such a clamping system may be provided for example in the form of at least one spring arm. If a bar is passed through the U-shaped recess, the spring arm rests under tension against the steel bar so that the device is fixed by clamping to the steel bar. In order to improve fixing, the spring arm may present protrusions that rest against the steel bar. These protrusions may be designed with a rubber-coated surface for example, which additionally improves the clamping effect.

The device is preferably designed in such a way that the section of the device presenting the means of configuration and capable of projecting above the upper concrete cover extends away from the reinforcement when the device is fixed to the reinforcement. Since this section must project upwards above the reinforcement on concreting of the latter, the device is preferably designed in such a way that this section essentially extends vertically, i.e. upwards, when the device is fixed to the reinforcement. In order to ensure that the section of the device presenting the means of configuration projects upwards above the concrete of the concrete component, the device according to the invention is dimensioned such that this section extends (vertically) away from the reinforcement beyond the necessary minimum dimension of the (previously calculated) upper concrete cover. This ensures that the dimension of the upper concrete cover is determinable by the device once the upper concrete cover has achieved the necessary minimum dimension. This minimum dimension of the upper concrete cover during calculation of a reinforced concrete component is denoted in DIN 1045-1 by nominal dimension cₘᵢₙ. Accordingly, it can be arranged that the section of the device presenting the means of configuration and capable of projecting above the upper concrete cover extends (vertically upwards) away from the reinforcement beyond the nominal dimension cₘᵢₙ according to DIN 1045-1.

Fundamentally, the section capable of projecting above the upper concrete cover may present any desired means of configuration by which the dimension of the upper concrete cover may be determined. This section may for example present at least one of the following means of configuration: a scale, alphanumerical data or geometric means of configuration.

A scale may be provided for example in the form of an indicating area with regular divisions that displays specific covering values. This indicating area may for example be printed on the section of the device or be formed on the latter by geometric means of configuration, for instance indentations, ribs or graduations. The scale may be provided in addition with alphanumerical data for example in order to allow direct and precise reading of the dimension of the upper concrete cover.

The section may also present means of configuration in the form of geometric means of configuration, with in view of a respective geometric means of configuration for example, a specific dimension of the upper concrete cover being determined or also directly indicated on this means of configuration, by alphanumerical data for example. According to a particularly preferred embodiment of the invention, the section of the device that projects above the upper concrete cover presents a slideable element, which is arranged to be movable, in particular essentially in the vertical direction, on the device. This slideable element may in particular be movable against a reinforcement to which the device according to the invention is fixed, in particular therefore movable downwards until it rests against the reinforcement. In this case, provision may in particular be made for the slideable element (in the downwards direction) being movable until it lies against the part of the reinforcement relevant for the upper concrete cover on which (reinforcement) the device is arranged. This part of the reinforcement relevant for the upper concrete cover—i.e. the part of the reinforcement with regard to which the dimension of the upper concrete cover must be observed—may in particular be the bottom boom of the braced girders.

The slideable element is a component of the section of the device which is designed to project above the upper concrete cover. In this case, the slideable element may present the aforementioned means of configuration, by means of which the dimension of the upper concrete cover is determinable. In addition, it is also possible of course for other components of the section designed to project above the upper concrete cover to present such means of configuration.

By means of the slideable element, the device is individually adaptable to the respective reinforcement on which it is fixed, provided that the dimension of the upper concrete cover of the reinforcement is directly readable on the slideable element and determinable by means of the slideable element. Since as a result of the slideable element being movable against the part of the reinforcement relevant for the upper concrete cover, the dimension of the upper concrete cover corresponds to the distance between the point at which the slideable element contacts the reinforcement on its part relevant for the dimension of the upper concrete cover and the point at which the concrete is present on the slideable element, i.e. the level or filling level of the concrete in the casting mould. The part of the reinforcement relevant for the upper concrete cover, against which (part) the slideable element is movable refers to the corresponding part of the reinforcement when the latter is contained in the casting mould and on the production pallet. In the case of the part relevant for the upper concrete cover, the vertically highest positioned area of the bottom boom of the braced girders of the reinforcement may for example be involved.

According to a preferred embodiment, the device presents a section by means of which a reinforcement to which the device is fixed can be applied to a support surface at a distance in relation to the latter. So-called bar spacers are known from the state of the art, which are fixable to a reinforcement and serve to apply the reinforcement at a distance in relation to a support surface, for example the base of a casting mould, to the latter. The lower concrete cover of a concrete component can be defined by appropriate bar spacers.

The section by means of which a reinforcement to which the device is fixable can be applied to a support surface at a distance in relation to the latter is capable of performing the function of such a bar spacer. The lower concrete cover is therefore definable and adjustable by means of this section. In addition, common commercially available bar spacers may also of course be fixed to the reinforcement. The particular advantage of such a section of the device serving as a “bar spacer” lies specifically in the fact that both the lower concrete cover and upper concrete cover are definable and adjustable by means of the device according to the invention.

Insofar as the device presents such a section serving as a “bar spacer”, provision may be made according to a further development of the invention for the device according to the invention presenting at least one section capable of projecting above the upper concrete cover on concreting the reinforcement that presents means of configuration by which the casting height of the concrete and the thickness of the concrete component can be determined. The casting height of the concrete corresponds to the thickness of the concrete component, i.e. the thickness of the concrete component between the surface of the lower and upper concrete cover of the concrete component. With a concrete component in the form of a semi-finished concrete slab, for example a ceiling slab, the thickness is known as the “board thickness”. In this case, the thickness of the concrete component corresponds to the board thickness which is directly determinable by the means of configuration.

The means of configuration of the section serving as “bar spacers” may be designed according to the means of configuration by which the upper concrete cover may be determined. Provision may be made for the device having a section on which both the means of configuration by which the dimension of the upper concrete cover may be determined and the means of configuration by which the casting height of the concrete may be determined.

According to one embodiment, provision is made for the device presenting several fastenings and at the same time several sections serving as “bar spacers”, which are employed depending on the lower concrete cover required. In this case, a section serving as a “bar spacer” is assigned to a specific fastening respectively, with the reinforcement being applicable over the respective bar spacer to a support surface at a respectively defined distance in relation to the latter. Furthermore, in this embodiment, a specific section of the device is assigned to each fastening which (section) presents means of configuration by which the dimension of the upper concrete cover may be determined. At the same time, a section of the device may be assigned to each fastening, which (section) presents means of configuration by which the casting height of the concrete may be determined. Both the upper and lower concrete cover can be adjusted by means of such a device; furthermore, the casting height may be determined.

Provision may be made for designing the slideable element as detachable and capable of being arranged at various different positions on the device. Each of the positions may be assigned to a specific fastening. The particular advantage of this is that only one slideable element needs to be provided when provision is made for a device with several fastenings.

In order to be able to securely move the slideable element on the device and at the same time be able to remove it from and reapply it to the latter, provision can be made for a rail system for example by means of which the slideable element can be moved on the device. The slideable element can for example be movably connected to the device by means of a tongue and groove system.

The device according to the invention has the further specific advantage that it can be designed very easily and also manufactured extremely economically. For example, the device may consist of plastic. In this case, the device may be finished in a single piece or in several pieces. Provision may be made for example for a plastic base body, in which case at least one of the components of the device can be manufactured as a separate plastic component that is connected to the device: fastening, means of configuration or slideable element.

The subject of the invention is furthermore a reinforcement for a concrete component, to which a device as described above is fixed. The subject of the invention is finally a concrete component with an internal reinforcement, to which a device as described above is fixed.

### BRIEF DESCRIPTION OF THE DRAWINGS

An example of embodiment of the device according to the invention is explained in further detail based on the description of the figures below. In this case:

FIG. 1 shows a front view of a device;

FIG. 2 shows a top perspective view at an angle of the device according to FIG. 1;

FIG. 3 shows a further top perspective view at an angle of the device according to FIG. 1;

FIG. 4 shows a front view of the device according to FIG. 1, fixed to a reinforcement;

FIG. 5 shows a front view of a slideable element; and

FIG. 6 shows a top perspective view at an angle of the slideable element according to FIG. 5.

### DETAILED DESCRIPTION

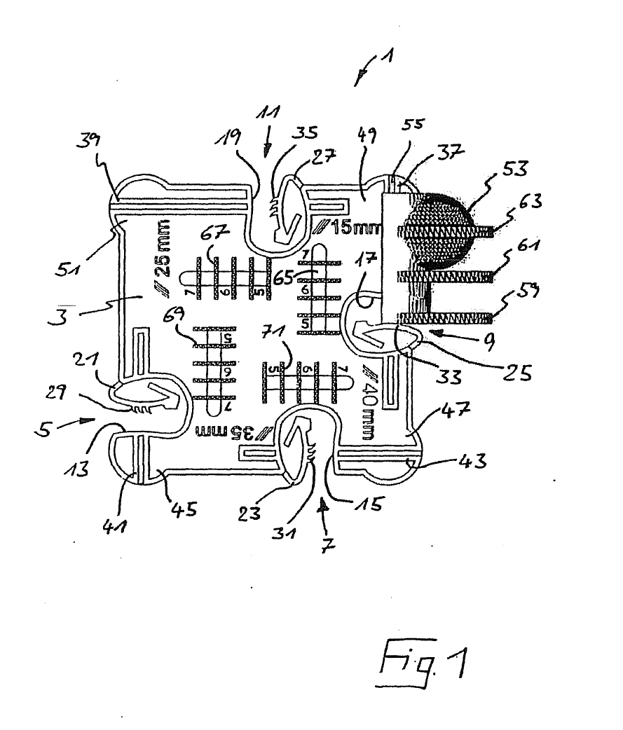

The device according to FIG. 1 is designated in its entirety by the reference 1. It presents an essentially cuboid base body 3 with opposite, essentially rectangular base areas. The base body 3 has protrusions at its four corners. In the area of the four side edges of the base body 3, a fastening 5, 7, 9, 11 is arranged on the latter respectively. Each fastening 5, 7, 9, 11 presents an essentially U-shaped recess 13, 15, 17, 19 respectively, each with an internal clamping system in the form of a spring arm 21, 23, 25, 27. Each spring arm 21, 23, 25, 27 presents three serrated protrusions 29, 31, 33, 35 respectively.

Each fastening 5, 7, 9, 11 is respectively dimensioned in such a way that as a result a steel bar of a reinforcement is fixable by partial encompassment and the device 1 is fixable by clamping on the encompassed steel bar. For this purpose, the U-shaped recesses 13, 15, 17, 19 of the fastenings 5, 7, 9, 11 respectively present a width of approximately 15 mm and a depth of approximately 20 mm. As a result of the spring arm 21, 23, 25, 27 arranged in the respective U-shaped recesses 13, 15, 17, 19, the respective overall width of the U-shaped recesses 13, 15, 17, 19 is narrowed by approximately 5 mm. Consequently, it is possible to push-fit the device by means of the respective fastening 5, 7, 9, 11 on to a steel bar respectively of a reinforcement with a diameter of approximately 10 mm and fix it by clamping to the steel bar by the protrusions 29, 31, 33, 35 of the respective spring arm 21, 23, 25, 27 resting under pre-tension against the steel bar.

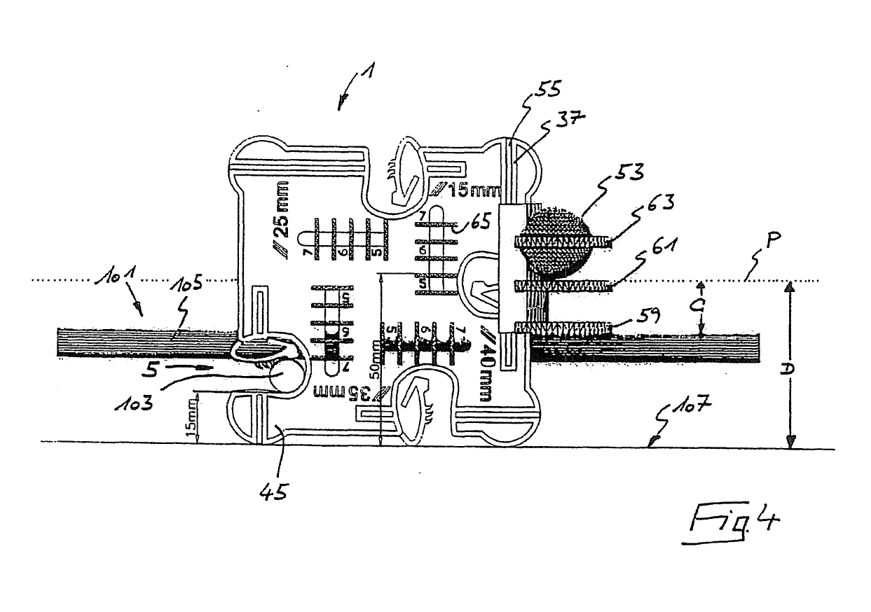

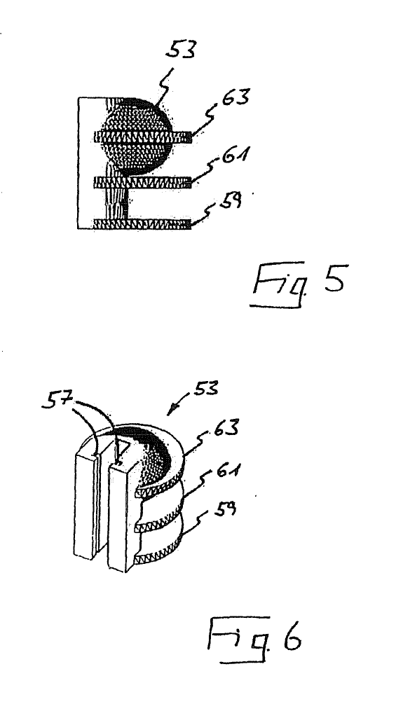

FIG. 4 shows a view of the device 1 in which the latter is fixed by means of the fastening 5 by clamping to a steel bar of a layer of lower rebars 103 of a reinforcement. The reinforcement 101 presents a layer of lower rebars 103 and a layer of upper rebars 105 arranged at a right angle to the latter. The layer of lower rebars 103 faces a support surface 107 of a casting mould, over which it is maintained at a specific distance by means of the device 1. For this purpose, the device presents sections 45, 47, 49, 51 serving as bar spacers, by means of which the reinforcement 101 is arranged at a specific distance in relation to the support surface 107. In this case, such a section 45, 47, 49, 51 is assigned to each fastening 5, 7, 9, 11 respectively. In the example of embodiment, the section 45 is assigned to the fastening 5. In the fixing of the device 1 to the reinforcement 101 according to FIG. 4, the reinforcement 101 can be applied over the section 45 to the support surface 107 at a specific distance of 15 mm. This distance of 15 mm corresponds to the dimension of the lower concrete cover.

The device 1 has four areas 37, 39, 41, 43 which can be supplemented respectively with a slideable element presenting a means of configuration. Such an area supplemented with a slideable element represents a section of the device with means of configuration, by which the dimension of the upper concrete cover can be determined. Each of the four areas 37, 39, 41, 43 which can be supplemented with a slideable element is assigned to a fastening 5, 7, 9, 11 respectively. A slideable element is push-fitted on to the area 37, 39, 41, 43 assigned to the respective fastening 5, 7, 9, 11 when the device 1 with the respective fastening 5, 7, 9, 11 is fixed on a bar of a layer of lower rebars of a reinforcement.

The area 37 of the device 1 is assigned to the fastening 5 so that according to the example of embodiment, a slideable element 53 is push-fitted on to this area 37. Concretely, the area 37 on the two base areas of the device 1 each presents a spring 55 respectively, which extend vertically in the position presented in FIG. 4 and are directly opposite one another. The slideable element 53 is guided movably with corresponding grooves 57 on these springs 55.

The slideable element 53 presents three disc-shaped elements 59, 61, 63 arranged above one another, which are evenly spaced from one another. The slideable element is movable in this case on the springs 55 in such a manner that in the position presented in FIG. 4, the underside of the lowermost disc-shaped element 59 is guidable against the upper edge of a bar of the layer of upper rebars 105 of the reinforcement. This upper edge of a crossbar 105 represents the area of the reinforcement 101 relevant for the upper concrete cover.

The two disc-shaped elements 61 and 63 arranged above the disc-shaped element 59 are designed as a scale, with the upper side of the middle disc-shaped element 61 running at a distance of 15 mm and the underside of the upper disc-shaped element 63 running at a distance of 25 mm over the underside of the lower disc-shaped element 59 and therefore also over the upper edge of the bar of the layer of upper rebars 105. With regard to the other fastenings 7, 9, 11 of the device 1, corresponding springs are arranged on the device 1 at the areas 39, 41, 43, so that if the device 1 were to be fixed on to a reinforcement by means of one of these fastenings 7, 9, 11, a slideable element 53 can be arranged at the areas 39, 41, 43 assigned to these fastenings 7, 9, 11.

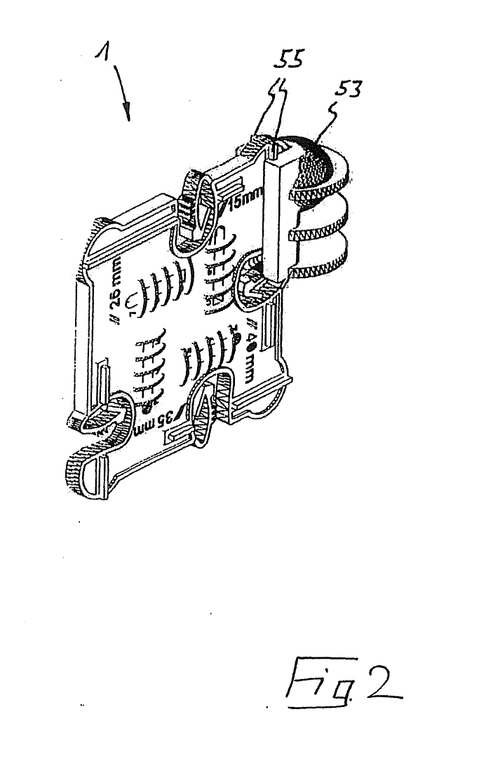

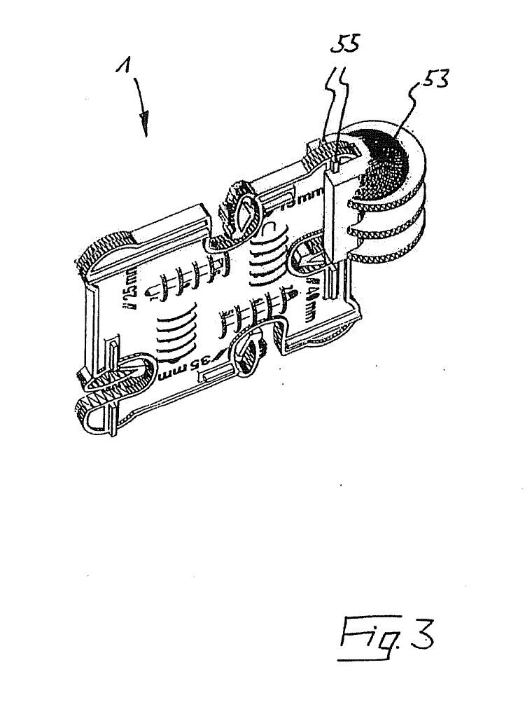

In FIG. 2 and FIG. 3, it can be particularly clearly seen how the slideable element 53 is movably guided on the springs 55. In FIG. 6, the springs 57 in particular of the slideable element 53 are clearly visible.

The device 1 furthermore has sections 65, 67, 69, 71 which present means of configuration by which the casting height can be determined. In this case, such a means of configuration 65, 67, 69, 71 is assigned to each fastening 5, 7, 9, 11. The means of configuration 65, 67, 69, 71 are each designed as a scale, so that the casting height can be directly read on the latter, when the device 1 is fixed to a reinforcement with a fastening 5, 7, 9, 11 assigned to the respective means of configuration 65, 67, 69, 71.

With regard to the embodiment presented in FIG. 4, in which the device 1 is fixed by means of the fastening 5 to a bar of a layer of lower rebars 103, the casting height can be directly read on the means of configuration 65 assigned to the fastening 5. The reinforcement 101 in the example of embodiment is arranged in a casting mould and is intended to be concreted in order to produce a semi-finished component in the form of a ceiling slab.

During practical use of a device 1 according to the example of embodiment presented, at least one device 1 is fixed on a bar of a layer of lower rebars of a reinforcement by means of a fastening 5, 7, 9, 11. For example, the device, as presented in FIG. 4, is fixed on a bar of a layer of lower rebars 103 of a reinforcement 101 by means of the fastening 5. In order to define the distance between the reinforcement 101 and the support surface 107—and therefore in order to simultaneously define the dimension of the lower concrete cover—the reinforcement 101 is additionally applied over further bar spacers at a specific distance of 15 mm on to the support surface 107. Provision may also be made for example for depositing the reinforcement 101 over several devices 1 spaced apart from one another and further “simple” bar spacers on to the support surface 107.

The slideable element 53 is subsequently push-fitted on to the springs 55 and slid downwards until the underside of the lower disc-shaped element 59 rests against the upper side of a bar of the layer of upper rebars 105. The upper side of the layer of upper rebars 105 is the area of the reinforcement relevant for the dimension of the upper concrete cover. The reinforcement 101 arranged accordingly on the support surface 107 of a casting mould is now concreted, i.e. cast over with concrete. Beforehand, a desired upper concrete cover of 15 mm was determined.

Accordingly, enough concrete is poured into the casting mould until the level of the concrete, implied by the dotted line P, reaches the upper side of the middle disc-shaped element 61. Since the upper side, as explained above, is at a distance of 15 mm from the upper edge of the bar of the layer of upper rebars 105, a dimension C for the upper concrete cover of exactly 15 mm is achieved and therefore no further concrete requires to be poured into the casting mould. Hence, the dimension C of the upper concrete cover is exactly adjustable and determinable. At the same time, it can be precisely determined by the means of configuration 65 that the casting height D and the board thickness is 50 mm.

1. A device for determining the dimension of an upper concrete cover of a concrete component, the device comprising:
at least one fastener which the device can be fixed to a reinforcement for the concrete component; and
at least one section adapted to project above the upper concrete cover on concreting the reinforcement;
the at least one section having a configuration by which the dimension of the upper concrete cover may be determined.

2. The device according to claim 1, wherein the fastener comprises clamping systems for clamped attachment of the device to the reinforcement.

3. The device according to claim 1, wherein the fastener a section capable of at least partially encompassing a steel bar of the reinforcement.

4. The device according to claim 3, further comprising a section having a form of an essentially U-shaped recess at least partially encompassing a steel bar of the reinforcement.

5. The device according to claim 4, wherein the U-shaped recess has an internal clamping system for clamped attachment of the device to a steel bar of the reinforcement.

6. The device according to claim 5, further comprising a clamping system including at least one spring arm.

7. The device according to claim 6, wherein the spring arm has protrusions operably resting against a steel bar of the reinforcement and the steel bar encompassed by the U-shaped recess.

8. The device according to claim 1, wherein the section projecting above the upper concrete cover presents at least one of the following configurations, by which the dimension of the upper concrete cover can be determined: a scale, alphanumerical data or geometric means of configuration.

9. The device according to claim 1, further comprising a section by which the reinforcement to which the device is fixed is operably applied to a support surface at a distance in relation to the latter.

10. The device according to claim 1, wherein the section capable of projecting above the upper concrete cover has a slideable element arranged to be movable on the device.

11. The device according to claim 10, wherein the slideable element is movable against the reinforcement to which the device is fixed.

12. The device according to claim 10, wherein the slideable element is movable against the area of the reinforcement to which the device is fixed relevant for the dimension of the upper reinforcement.

13. The device according to claim 1, is made of plastic.

14. A reinforcement for a concrete component with a device according to claim 1 fixed to the reinforcement.

15. A concrete component with an internal reinforcement to which a device according to claim 1 is fixed.
